(19) United States
(12) Patent Application Publication
(10) Pub. No.: US 2008/0015927 A1
(43) Pub. Date: Jan. 17, 2008

(54) System for Enabling Secure Private Exchange of Data and Communication Between Anonymous Network Participants and Third Parties and a Method Thereof

(76) Inventor: Francisco J. Ramirez, Bellevue, WA (US)

Correspondence Address: Jay M. Schloff;Intellipex PLLC, Suite 245, 30200 Telegraph Road, Bingham Farms, MI, 48025, US

(21) Appl. No.: 11/778,643

(22) Filed: Jul. 16, 2007

Related U.S. Application Data
(60) Provisional application No. 60/807,607, filed on Jul. 17, 2006.

(51) Int. Cl. G06F 17/30

(52) U.S. Cl. 705/10

(57) ABSTRACT

Disclosed is a method for providing secure private exchange of a profile data of a network participant between the participant and a plurality of third parties. The method comprises registering profile data by the network participant with a privacy control unit, assigning privacy levels to each of the plurality of attributes of the profile data, transferring the profile data along with privacy levels assigned to each of a plurality of attributes of the profile data to a privacy control unit generating a report for research and for targeting promotion campaigns to the network participant by using the profile data. The report is accessed by the plurality of third parties for communications with the network participant, wherein the plurality of third parties are registered with and invoiced by the privacy control unit. A portion of the invoice is provided as a fee to the network participant for providing the profile data.

### REFERENCE TO PRIOR APPLICATIONS

This application claims the priority of U.S. Provisional Application 60/807,607, filed on Jul. 17, 2006.

### FIELD OF THE INVENTION

The present invention relates to web based transfer of data for market research, direct marketing and sales and such purposes, and, more particularly, to a privacy control unit for providing secure exchange of data between concerned parties.

### BACKGROUND OF THE INVENTION

Today the market for collection, resale and use of data is a varied landscape. Collection, gathering and exchange of data are performed by specific organizations that manage and present the data in a network. The data can be contact details or profile information of end users that are target customers for organizations for marketing and sales. There are numerous business and marketing organizations that cater to the need of information in the market and multiple applications designed to address research and marketing needs of business. These organizations exchange data in an interactive communication network. The interactive communication network can be an internet or an intranet. The data is stored in a web server at a content source website, which is connected to the interactive communication network. Network participants, who are information seekers, clients or end users of a content source website, access the data at the content source website by engaging a web application server via software commonly referred to as a browser.

The organizations catering to the need of the data mainly include market research and analytics firms, database and directory publishers, survey firms and advertising service agencies. The market research and the analytics firms systematically gather, record, tabulate and present market and public opinion data using client software to track an online behavior of the end users who visit the content source websites. Further, new vendors empower individuals to share their profile data online and entice the individuals to participate. Such vendors promise a reward similar to a lottery promotion. Many vendors veil their collection of data within the context of providing another service. Some vendors gather or supplement their data or purchase it from secondary sources including public records. Statistical techniques are then applied to determine quantitative and qualitative data about the end users.

Alternatively, research firm's use statistical modeling in conjunction with a third party data sources and network information to make informed estimates. Some vendors gather data from partners that control internet access, for example, internet service providers. Many vendors in the industry are criticized as the data they aggregate is most often collected without the cognizance permission or knowledge or compensation for the individual to whom the data concerns.

The database and directory publishers are engaged in publishing compilations and collections of information or facts that are logically organized to facilitate the use of the information or the facts. The database and the directory publishers provide electronic versions of the information directly to the network participants or offer the information online or by using third-party vendors. The database and directory publishers aggregate, repackage and resell the information. The resale of a collection of physical addresses has resulted in tremendous volumes of Junk Mail, while the resale of e-mail addresses have resulted in flood of irrelevant e-mails commonly referred to as SPAM. These Junk and SPAM mails are viewed by their recipients as unnecessary and undesired direct marketing.

The advertising service agencies are dedicated to creating, planning and handling advertising for its clients and advise, consult and manage promotional efforts of their clients. Generally, the advertising service agencies are customers of the market research and analytics firms, and the advertising service agencies. These agencies provide an online platform for internet services that align the promotional effort of its clients with the target customers of its clients by following some basic protocols. Recently, the advertising service agencies have adapted a strategy of advertising with an option of internet search terms via keyword purchase. The keyword purchase includes auctions of the items of its clients and a Pay-Per-Clicks (PPC) pricing mechanism. Some of these agencies also use a finite set of profile data and the end-user behavior to provide more targeted advertising services based on the end-user behavior and limited demographics. However, these agencies provide this functionality within their network and document interaction with content sources that they manage. Further, under these reactive advertising service models the burden of searching for data is placed upon the network participant.

A paid search or sponsored search of the advertising service agencies attracts end users to the content source website, may also collect information on the end users. However, the data gathered from the end users is neither substantially qualitative nor quantitative as to the character of the visiting end user. Website owners can not identify the individual. The end user data may be generally abstract, generic, and non-substantive in form. This method results in an inability for the content source website to neither understand the character of the visitor of the content source website nor follow-up in an actionable manner with the content source website visiting end user. The collected data can be of type such as: the number of end users visiting the website; the number of new and repeat website visitors; frequency of end users visits; and the information of the end user including IP address, type of browser used by the end user and the end user's operating system. The nature of the collected data may be of interest to a web developer, but it is of marginal value to marketers and salespersons. In other words, this information provides little insight into interest, preferences, resources, character and behavior of the end users.

The content source website providers can provide a small degree of personalization to the end users by browsing cookie data and limited registration of end user profile data. While end users might also register and provide profile information, the data is rarely compiled in a manner that safeguards the privacy of the individual collecting, maintaining, and securing the profile data; and the registration information is especially difficult for the small content source website providers with limited resources. Further, the content source website providers also have limited ability to address inconsistencies in their data which result from changes in the lives of the network participants. As a result content source website providers may be burdened with managing privacy, security, changing profiles attributes, and multiple profiles (if any) of the end users.

Apart from the market research, the web based direct marketing and sales services have become popular with the increasing accessibility of data via the internet and growth in peer-to-peer communication. Due to the lack of contact and profile data of the end users (target customers), the marketing and sales professionals make a direct request to the end users who visit the websites to register their contact data and profile information. However, the response rate to the request of registering the contact data and profile information is very limited due to the lack of trust and privacy concerns. Other factors include lack of patience, possibility of getting unnecessary e-mails and phone call solicitations, and confusion over inconsistent privacy models across websites. Also, a desire for anonymity and inability to manage multiple identities used to secure privacy decreases the interest and capability of website visitors in updating their profile data.

A desire for anonymity and registration brevity combined with a lack of trust has resulted in limited success in requesting website visitors to provide valid or comprehensive registration data. This has resulted in the emergence of a secondary market of database and directory publishers. These databases and directory publishers compile disparate demographic data, repackage and sell such data to interested parties. This data is often out of date and exchanged without the knowledge, permission, or compensation to the individual or entities to which the data is related. In addition, data is purchased and sold without or little concern of the privacy interest of the individual or entities.

The existing techniques of the market research and the direct marketing have numerous other pitfalls due to the inefficiency and ineffectiveness of these techniques. These pitfalls include interruption of the network participants content source experience, a management burden of dealing with uncontrolled flood of SPAM e-mails, unwanted telemarketing phone calls, junk mail management, less conversion rate of direct marketing efforts, costly market research and product and service failures and missteps resulting from a lack of the good market data.

There have been some incremental measures adapted to address these pitfalls, including adoption of mail management services and delivery channel filtering service models. In the United States there have been some selective efforts with Do-not-mail/call registries and delisting services, and even legislative regulation in specific industry verticals (finance, health, entertainment, and the like). The mail management and filtering services limits SPAM e-mails based on the escrow permission and evaluation model. The escrow-based protocols appear to have roots in community defined parameters, with new proposals based upon frameworks that emulate existing security key management systems. Such protocols rely upon the creation of a central governing authorities to manage black and white list of senders of e-mails based on community based rules and behavior.

There are also technically based solutions to address SPAM such as promoting the adoption of ‘sender ID’. These solutions help in the filtering of the SPAM mails, but they fail to address the main problem of telemarketers or telesales as to the lack of information of the true nature of the customer's wants, needs, preferences and their resources. These solutions are further unable to fulfill the target promotions to the specific prospects. In spite of the technical advancements and legislative regulations, unwanted phone calls and SPAM e-mails still continue to trouble the individuals. Moreover, technical advances in IP-based telephony offer the potential for a ‘voice SPAM’ which is equally as troublesome as Junk physical mail, SPAM emails and unwanted phone calls.

Physical junk mails continue to plague individuals, as is evident from environmental survey data of the United States Postal Service showing that United States households received 94.8 billion pieces of advertising mail in year 2004. About 83 percent of the all-advertising mails received by household are sent as standard mail, which is a total of 78.1 billion pieces in year 2004. Environmental organizations estimate that 100 million trees are harvested annually to support American businesses direct advertising mail habit. The direct marketing associations provide registration services to allow individuals to opt out of direct marketing solicitations, but the problem continues to plague the individual and the environment. Authorities have made attempts to deal with direct marketing drawbacks using the legislation and technological methods. Legislation suffers its problems in defining the abstract problem, jurisdictional obligations, policing and cost allocation across an ecosystem of participants.

Many unscrupulous vendors have created software that monitors client's actions and reports them back to a source without the clients knowledge and without compensation. The software or the spy ware has given rise to privacy management and security filtering software. Organizations engaged in this practice do so in a manner that is purposefully obtuse. These organizations rationalize the use of this data under ulterior benefit claims, and are not forthright in their internal use of data. Most privacy statements and documents are less than clear on how the data is used.

Based on the above discussions, there is a need of a technology centric solution that provides a greater qualitative and quantitative value to the information exchange between individual consumers and organizations. The technology-centric solution should also be capable of redefining the existing processes, economic systems and focus on the values and privacy policies provided by the network participants in the information exchange and use. Also, what is needed is a solution that is capable of maintaining the privacy of the end users and can provide a simple and reliable online platform to manage the communications throughout the marketing and sales processes.

### SUMMARY OF THE INVENTION

In view of the foregoing disadvantages inherent in the prior art, the general purpose of the present invention is to provide a method and a system for secure exchange of profile data of a network participant between the network participant and a plurality of content source websites, to include all the advantages of the prior art, and to overcome the drawbacks inherent therein to add unique value.

The present invention provides a method for secure exchange of a profile data of a network participant between the network participant and a plurality of content source websites. The method comprises registering the profile data by the network participant with a privacy control unit, wherein the profile data comprises a plurality of attributes. The method further comprises assigning privacy levels to each of the plurality of attributes by the network participant. Furthermore, the method comprises distributing a token to the network participant by the privacy control unit, the token serving as a proxy for the profile data of the network participant and the privacy levels assigned to each of the plurality of attributes. Thereafter the token is routed to a web beacon of the privacy control unit that is resident on a content source website of the plurality of content source websites by the network participant accessing the content source website and a report for research and for targeting promotion campaigns is generated for the content source websites. Additionally, the tokens collected enable the content source websites to target promotion campaigns to the network participant without specific knowledge of the network participant's identity, contact information, or specific attributes. The method further comprises charging the content source website through an invoice generated by the privacy control unit for providing reports and for empowering varied types of communications with network participants. A portion of the invoice is provided to the network participant for providing the profile data and responding to the communications from the content source websites delivered to the network participant by the privacy control unit. The portion of the invoice provided to the network participant is consistent with a quality and volume of the profile data provided by the network participant and their evaluation, consideration, and participation in communications delivered by the privacy control unit.

The present invention also provides a method of secure exchange of a profile data of a network participant between the network participant and a plurality of content sources. The method comprises installing of software on the network participant, the software monitors use and behavior pattern of the network participant upon network participant confirming the installing of the software. The method further comprises transferring the profile data along with privacy levels assigned to each of a plurality of attributes of the profile data to a privacy control unit periodically through the software installed on the network participant. Furthermore, the method comprises generating a report for research and for targeting promotion campaigns to the network participant by using the profile data transferred through the software, wherein the report is generated by the privacy control unit. Further the report is accessed by the plurality of content sources for communications with the network participant, wherein the plurality of content sources are registered with the privacy control unit. Thereafter, the plurality of content sources are charged through an invoice generated by the privacy control unit for providing the report and empowering communications, wherein a portion of the invoice is provided as a fee to the network participant for providing the profile data to the plurality of content sources and evaluating or responding to communications delivered through the privacy control unit.

The present invention provides a system for providing secure exchange of a plurality of profile data and maintenance of individual privacy associated with the plurality of attributes that comprise the profile data. The present invention also provides a system for providing secure exchange of communications associated with the plurality of network participants by the plurality of content sources that use the privacy control unit. The system comprises a plurality of network participants. The system further comprises a plurality of content sources, wherein each of the plurality of network participants is capable of accessing the plurality of content sources.

Furthermore the system comprises a privacy control unit comprising a database for storing the plurality of profile data and privacy levels for each of a plurality of attributes of each of the plurality of profile data, wherein a profile data of the plurality of profile data is voluntarily and knowingly registered by a network participant of the plurality of network participants with the privacy control unit, a token management system capable of distributing a token of a plurality of tokens to the network participant of the plurality of network participants, the token comprising the profile data of the network participant and a privacy level assigned to each of the plurality of attributes of the profile data, and routing the token through a web beacon in a content source website of the plurality of content source websites to the privacy control unit upon the network participant accessing the content source website.

A business intelligence module for generating a report for research and for targeting promotion campaigns to the plurality of network participants by using the token, and an accounting module for invoicing the content source websites or third party organizations of the plurality of content source websites or third party organizations and giving a fee to the network participant for providing the profile data and responding to communications from the content source website or other organization utilizing the services of the privacy control unit by registering with the privacy control unit.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 is a block diagram of a system 100 for secure exchange of a plurality of profile data between a plurality of network participants and a plurality of content source websites, in accordance with an embodiment of the present invention;

FIG. 2 is a detailed illustration of the system 100, according to an embodiment of the present invention;

FIG. 3 is a flow diagram of interactions between a network participant and the plurality of content source websites, according to an embodiment of the present invention;

FIGS. 4-A,B is a flow diagram illustrating tasks performed by the network participant, privacy control unit and a content source website for providing secure exchange of the profile data between the network participant and the content source website through the privacy control unit, according to an embodiment of the present invention;

FIG. 5 is a flow diagram along with databases for assignment of a token to the network participant, according to an embodiment of the present invention;

FIG. 6 is a flow diagram illustrating a method for providing secure exchange of a profile data of the network participant between the network participant and the plurality of content source websites, according to an embodiment of the present invention;

FIG. 7 is a flow diagram of a method for secure exchange of the profile data between the network participant and a plurality of content sources, according to an embodiment of the present invention; and

FIGS. 8A, 8B and 8C are diagrams of a widget deployed on the network participant, multilevel marketing widget and operational process of multilevel marketing widget, according to an embodiment of the present invention.

Like reference numerals refer to like parts throughout the description of several views of the drawings.

### DETAILED DESCRIPTION OF THE INVENTION

For a thorough understanding of the present invention, reference is to be made to the following detailed description, including the appended claims, in connection with the above-described drawings. Although the present invention is described in connection with exemplary embodiments, the invention is not intended to be limited to the specific forms set forth herein. It is understood that various omissions and substitutions of equivalents are contemplated as circumstances may suggest or render expedient, but these are intended to cover the application or implementation without departing from the spirit or scope of the claims of the present invention. Also, it is to be understood that the phraseology and terminology used herein is for the purpose of description and should not be regarded as limiting as the common vernacular used in the industry is not fully matured and is subject to different degrees of interpretation by online advertising and privacy industry specialists

The terms “a” and “an” herein do not denote a limitation of quantity, but rather denote the presence of at least one of the referenced item.

A privacy control unit is provided to broker transaction between a plurality of network participants and a plurality of content source websites. The plurality of content source websites requires information about the plurality of network participants, such as, static data (for example name, parents name, college name, and the like) or a dynamic data (for example, demographics, psychographics, keywords of interest, online behavior and purchases pattern of the network participant) used for effectively targeting promotional campaigns or research queries. The plurality of network participants registers a profile data with a privacy control unit. The profile data includes a plurality of attributes. Further, the plurality of network participants assigns privacy levels to each of the plurality of attributes.

The privacy control unit distributes a token to the network participant. The token serves as a proxy that comprises the profile data of the network participant and the privacy levels assigned to each of the plurality of attributes. Thereafter, the token is routed via a web beacon located at the content source website of the plurality of content source websites to the privacy control unit when the network participant accesses the content source website. A report is also generated by the privacy control unit for targeting promotion campaigns to the network participant by using the token. The content source website is charged through an invoice generated by the privacy control unit for providing the report and empowering communications with network participants. Further, in case of change in an attribute of the plurality of attributes of the profile data, for example, if the network participant has changed an attribute associated with their satisfaction with a mobile phone service provider, then other mobile phone service providers can target promotional campaigns to the network participant based on the fact that the attribute changed.

A portion of the invoice is provided to the network participant for providing the profile data and/or reviewing promotions delivered to the network participant by the privacy control unit. The portion of the invoice provided to the network participant is consistent with a quality and volume of the profile data provided by the network participant. For example, if a first network participant provides a richer profile data compared to a second network participant, then the first network participant receives more earnings as compared to the second network participant.

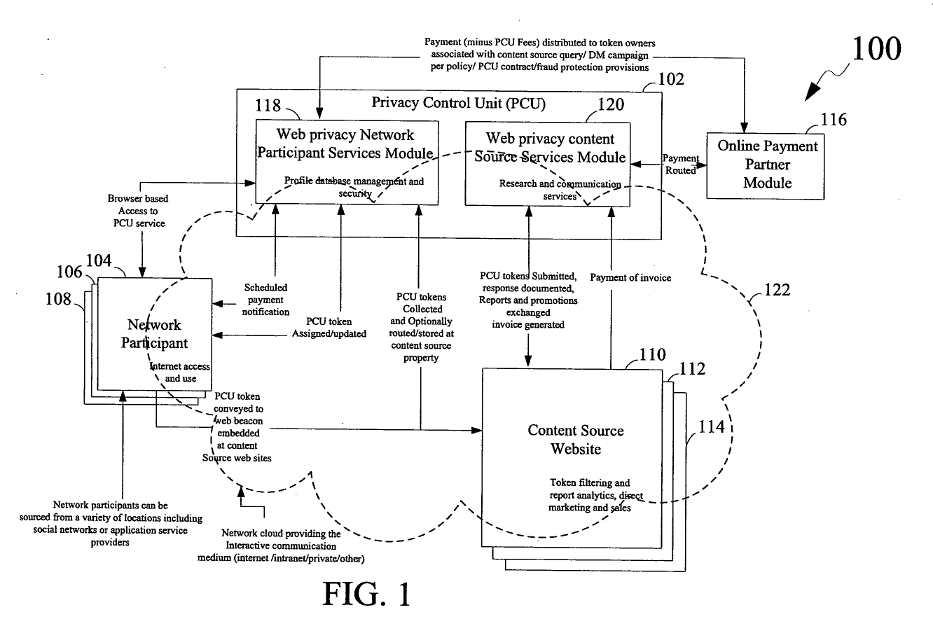

FIG. 1 is a block diagram of a system 100 for secure exchange of a plurality of profile data. The system 100 comprises a Privacy control unit (PCU) 102, a plurality of network participants 104, 106, 108, a plurality of content sources, for example, content source websites 110, 112, 114 and an online payment partner module 116. As used herein, a network participant may refer to one of an Internet service subscriber, a network application and a user of a computing device in a network. As used herein, content source may refer to a content source website or any other third party organization that desires to communicate with the network participant.

The PCU 102 supports communication between clients (for example, the network participant 104) and internet servers and content sources, (for example, the content source website 110). The PCU 102 manages secure exchange of a profile data between the network participant 104 and the content source website 110. Further the PCU 102 manages interactions between the network participant 104 and third parties. More specifically, the PCU 102 acts on behalf of the network participant 104 while communicating with a third party. The third parties may be interested in a usage pattern of the content source website 110 by the plurality of network participants, for example the network participant 104.

The PCU 102 includes a web privacy network participant services module 118 (also herein referred to as network participant services module 118) and a web privacy content source services module 120 (also herein referred to as content source services module 120). The network participant services module 118 serves as a link for communication between the network participant 104 and the content source website 110. The network participant 104 registers the profile data comprising the plurality of attributes with the network participant services module 118. Further the network participant 104 assigns a privacy level to each of the plurality of attributes of the profile data. Examples of the attributes of the profile data include, but are not limited to, name, telephone number, address, profession, salary, company and designation.

The content source services module 120 serves as a means for communication between the content source website 110 and the network participant 104. The content source website 110 make a request for logging into the PCU 102 through the content source services module 120.

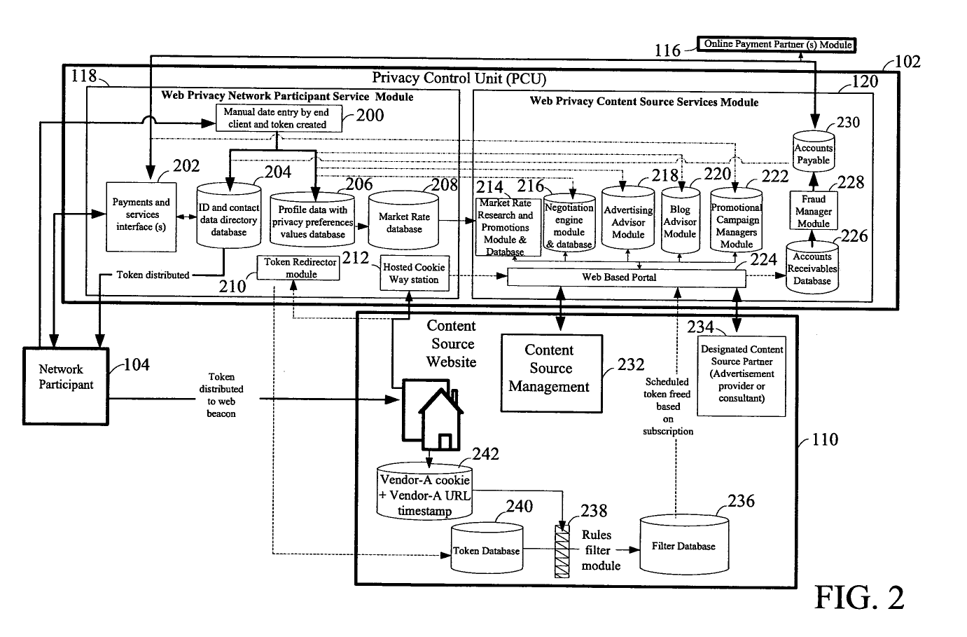

The content source services module 120 provides the profile data to the content source website 110 according to the privacy levels assigned to each of the plurality of attributes of the profile data. Further, the content source services module 120 provides a cost associated with the profile data of the network participant 104 to the content source website 110. The content source website 110 may negotiate the cost with the content source services module 120 or be served a fixed subscription cost for provision of research services. Once the cost for the profile data is mutually agreed by the content source services module 120 and the content source website 110, then an invoice is generated and the content source website 110 needs to make payment (corresponding to the invoice) for the profile data provided to the content source website 110 by the PCU 102. Also, a portion of the invoice is to be paid as fees to the network participant 104 for providing the profile data. The network participant services module 118 and the content source services module 120 will be described in conjunction with FIG. 2.

The PCU 102 or the online payment partner module 116 provides a payment mechanism for generating the invoice and distributing the fees to the network participant 104 for providing the profile data to the content source website 110 and responding to communications through the PCU 102. Once the content source website 110 make the payment to the PCU 102, the online payment partner module 116 deducts a PCU 102 management fee and distributes the remaining payment as the fees to the network participant 104.

The PCU 102 provides a web based user interface to the network participant 104 for communicating with the PCU 102. The web based user interface may be based on one of a Hyper Text Markup Language (HTML) and eXtensible Markup Language (XML) or a future network content authoring variant. The network participant 104 visits the web based user interface of the PCU 102 using a computing device (for example, a desktop, a laptop, mobile phone, a personal digital assistant or other computing devices connected to a network). The network participant 104 communicates through a network 122 with the PCU 102. The network participant services module 118 distributes a token to the network participant 104 after the profile data is registered with the PCU 102 by the network participant 104. The token has a unique name value pair and by proxy includes the profile data along with the privacy levels assigned to each of the plurality of attributes of the profile data.

As used herein, a token or a cookie is a text that a web server can store in a hard disk or other computing device memory of user of the network. Cookies are stored in one of a memory and a hard disk. The cookie stored in the hard disk is stored as name-value pair in a cookie file. For example, in a Microsoft Windows platform the cookies may be stored using the Internet Explorer program in a directory called c:\windows\cookies with each cookie in the text that contains the name-value pair. For each of the plurality of content source websites 110, 112, 114 visited by the network participant 104, a cookie file is maintained in the memory of the network participant-computing device.

A content source website, for example, the content source website 110, may retrieve the information corresponding to the cookie which is the proxy for the profile data of a network participant, for example, the network participant 104. The PCU 102 provides the profile data of statistically significant aggregated set of the network participants 110, 112 and 114. The system is designed to protect privacy through a plurality of statistical aggregation and technical brokering techniques. Additionally, the PCU 102 uses these techniques to provide industry benchmark reports for a single content source website (for example, the content source website 110) relative to the aggregated set of other content sources (for example, a content source website in a specific industry).

Upon the network participant 104 accessing the content source website 110, the PCU 102 collects the token from the network participant 104 and stores the token in a database. The content source website 110 accesses the database to view the anonymous aggregated attribute data associated with the tokens of the network participants 104. The access to the token allows the content source website 110 to purchase the profile data of the network participant 104 according to the privacy levels assigned to each of the plurality of attributes of the profile data through the PCU 102.

FIG. 2 is a block diagram of the system 100 illustrating in detail the modules/components of the content source website 110, the network participant services module 118, and the content source services module 120. The network participant 104 registers the profile data with the PCU 102 and the token is created as shown with reference to a block 200.

The network participant services module 118 includes a payments and services interface module 202, a plurality of databases 204, 206, 208, a token redirector module 210, and a hosted cookie way station module 212. The payments and services interface module 202 is a web based tool for assisting the plurality of content source websites 110, 112 and 114 in building marketing promotion and research campaigns for the plurality of network participants 104, 106 and 108. The payments and services interface module 202 is used for targeting, creating and delivering research in a presorted and prioritized manner. Further, promotion campaigns for the plurality of network participants 104, 106 and 108 are based on a single algorithm that incorporates the superset of profile data including, the plurality of attributes, for example demographics, psychographics, keywords, life events, online behavior, offline purchase behavior, and historical patterns of responsiveness to solicitations by the network participant 104. The database 204 contains identification information and contacts directory of the plurality of network participants 104, 106 and 108.

The database 206 includes the plurality of profile data registered by the plurality of network participants 104, 106 and 108 and the privacy levels assigned to each of the plurality of attributes of the profile data. The plurality of profile data stored in the database 206 are benchmarked and reported against a membership base and statistics from third parties providing members insight into the plurality of attributes of each of the plurality of profile data relative to a comparative audience.

The profile data is stored in the token. The token serves as a proxy for the profile data along with the privacy levels assigned to each of the plurality of attributes. The database 208 referred to as a market rate database comprises a monetary value of the plurality of network participants 104, 106 and 108 associated with the plurality of attributes of the profile data. Tokens stored in the database 208 can be redirected to the plurality of content source websites, for example the content source website 110, by the token redirector module 210. The hosted cookie way station module 212 is the principal means used for managing the database of tokens collected by the content source websites 110, 112 and 114.

The content source services module 120 includes a market rate research and promotions module and database 214, a negotiation engine module and database 216, an advertising advisor module 218, a blog advisor module 220, a promotional campaign managers module 222, a web based portal 224, an accounts receivables database 226, a fraud manager module 228 and an accounts payable module 230. The web based portal 224 is used for providing a single web based user interface to the plurality of content source websites 110, 112 and 114 for managing research and promotion efforts. Access to the web based user interface is governed by standard web based security technologies; methods and processes like those used by trusted financial institutions and designed to protect commercial transactions.

The web base portal 224 provides access to the market rate research and promotions module and database 214 for providing a report to the plurality of content source websites 110, 112 and 114. The market rate research and promotions module and database 214 will also be referred to herein as a business intelligence module 214. The report includes a set comprising aggregate prices proved to be successful in securing the attention and evaluation promotions by a plurality of network participants 104, 106 and 108. The report is used by the plurality of content source websites 110, 112 and 114 to budget the promotional campaigns and research accordingly. The negotiation engine module and database 216 negotiates the price of the attention and the profile data of the network participant 104, thereby helping the plurality of content source websites 110, 112 and 114 in budgeting the promotional campaigns and research.

Further, the price negotiated is stored in a database for maintaining records of the price for future or any other use. The negotiation engine module and database 216 may be implemented using a web based user interface. The advertising advisor module 218 assists in utilizing the profile data stored in the database for targeting and structuring promotional efforts in media. The advertising advisor module 218 uses the preference of the plurality of network participants 104, 106 and 108 while accessing the plurality of content source websites 110, 112 and 114. The promotional campaigns may be at least one of an online media, print media and electronic media.

The blog advisor module 220 is used for targeting a blog based promotional campaigns by the plurality of content source websites 110, 112 and 114. The blog advisor module 220 uses the profile data regarding blog use, preference, and consumption to assist the plurality of content source websites 110, 112 and 114 in targeting blog based promotional campaigns. The promotional campaign managers module 222 is a database tool that assists in building direct marketing campaigns for the plurality of network participants 104, 106 and 108 based on the preferences of the plurality of network participants 104, 106 and 108. Furthermore, the promotional campaign managers module 222 monitors the response of the plurality of network participants 104, 106 and 108 based on the direct marketing metrics and derives fees based on evaluation and response by the plurality of network participants 104, 106 and 108.

The accounts receivables database 226 includes receipts for the research and promotional services. The fraud manager module 228 uses statistical analytical methods for identifying likely sources of frauds before the payment. The fraud manager module 228 collaborates with payment vendors for preventing fraud by using common geo tracking of IP addresses and abnormal account activity, and by sharing a blacklist of fraudulent users. The account payable database 230 includes details of the payments by the plurality of network participants 104, 106 and 108 and the payment to third parties, for example, nonprofits designated by the network participant 104. The accounts payable module 230 also allows for the network participant 104 or partner organizations of the PCU 102 to receive payments for referring other network participants to use the system 100. The accounts receivables database 226 and the accounts payable database 230 may be herein also referred to as an accounting module.

The content source website 110 includes a content source management 232, for example, a content source employee or a person who has access rights to the tokens collected from the PCU 102. The content source website 110 has an option of utilizing a third party marketing consultants proxy for building marketing campaigns, a designated content source 234 are marketing consultants for devising the promotional campaign and marketing strategies for the content source website 110.

As an option for long term trend based research and marketing a token database 240 may be used for storing the tokens received through a web beacon from the plurality of network participants 104, 106 and 108 accessing the content source website 110. A rules filter module 238 is used for filtering the tokens according to various categories based on the attributes in the profile data. The rules filter module 238 helps in trend analysis and in building retention focused marketing campaigns. A filter database 236 includes a set of tokens. The set of tokens are grouped, based on the rule filtering of tokens done by the rules filter module 238. The database includes tokens segmented into logical groups. The content source website further includes a database 242 for storing vendor-A cookie, a universal resource locator (URL) address, and a timestamp.

The various components of the system 100: the DM campaign payments module 202, the plurality of databases 204, 206, 208; the token redirector module 210; the hosted cookie way station module 212; the content source services module 120; the market rate research database 214; the negotiation engine module 216; the advertising advisor module 218; the blog advisor module 220; the DM campaign manager module 222; the web based portal 224; the accounts receivables database 226; the fraud manager module 228; the accounts payable database 230; the filter database 236; the rules filter module 238; and the token database 240 may be implemented as hardware, software or any combination thereof.

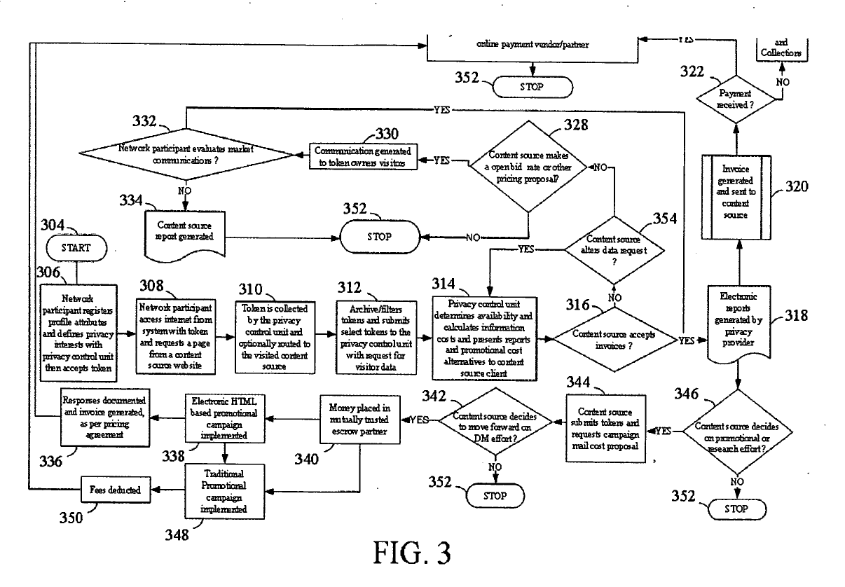

FIG. 3 is a flow diagram of interactions between a network participant (for example, the network participant 104) and the content sources (for example, the content source websites 110, 112, 114) for research and marketing decisions. The method is initiated at step 304. At step 306, the network participant 104 registers the profile data and assigns privacy levels to each of the plurality of attributes using the network participant services module 118. The network participant services module 118 distributes a token to the network participant 104.

The plurality of content source websites 110, 112 and 114 can retrieve the network participants 104, 106 and 108 information via the proxy through the web beacon system of the PCU 102. However, a content source website, (for example, the content source website 110) may only retrieve the information corresponding to the proxy containing an aggregated set of network participants (for example the network participants 104, 106, 108).

Further, the block 200 (See FIG. 2), allows the plurality of network participants 104, 106 and 108 to manually indicate to the PCU 102, when the plurality of network participants 104, 106 and 108 are not interested in being contacted by a particular content source of the plurality of content source websites 110, 112 and 114. This is similar to a ‘do not call list’ used to curtail telemarketing.

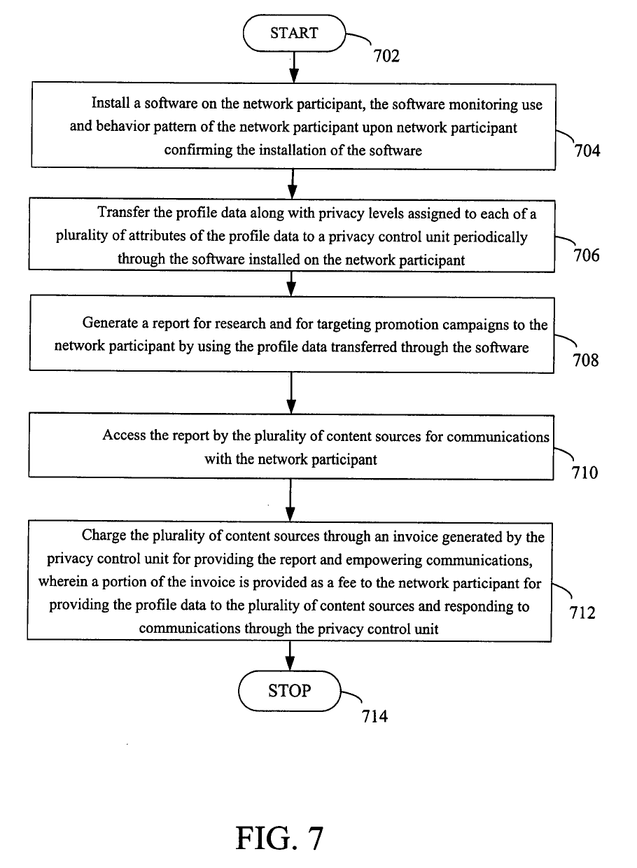

At step 308, the network participant 104 accesses internet and visits a page in the content source website 110. Herein, the content source website 110 has registered with the PCU 102. At step 310, the PCU 102 routes the token to the content source website 110. At step 312, a plurality of such tokens is optionally collected by the content source website 110 and is filtered using rules filter module 238. The selected tokens are stored in the token database 240 or more likely at the hosted cookie way station module 212 or at both. At 314, the PCU 102 determines availability and cost associated with the tokens and sends a message to the content source website 110 specifying the cost of the profile data associated with the token. The step 314 is only required for transactional use of the PCU 102, which will be described in conjunction with FIG. 7. The content source websites 110, 112 and 114 using the PCU 102 will be bound to license subscription agreements and the step 314 for determining availability and cost associated with the tokens is not required. At step 316, it is determined whether the content source website 110 accepts the cost of accessing the profile data or communicating with the network participants associated with the collected tokens. If the content source website 110 accepts the cost at step 318, the PCU 102 generates a report regarding the profile data and the report is made available to the content source website 110 by the PCU 102 using a secure web portal. If content source credit records are on file a automated deduction from the credit card will be made at the time service is provided.

At step 320, an invoice is generated and sent to the content source website 110. At step 322, it is determined whether the payment is received. If the payment is not received then the content source website 110 is blacklisted. If the payment is received then at step 326, a portion of the payment received from the content source website 110 is paid as fees to the network participant 104 for their portion of the profile data transferred to the content source website 110. Further, a portion of the payment received is retained by the PCU 102 for privacy and brokerage services rendered. The method terminates at step 352.

If the content source website 110 does not accept the cost of the token, then at step 354, it is determined whether the content source website 110 changes the scope of the profile data requested. If the scope of the profile data requested is changed, then the control goes back to step 314. If the content source website 110 does not change the data request then, at step 328, it is determined whether the content source website 110 makes an open bid rate or other pricing proposal. If the content source website 110 makes the open bid rate or other pricing proposal to the network participant 104, then at step 330, the PCU 102 communicates to the network participant 104 or to network participants with the profile data substantially similar to the network participant 104. The PCU 102 informs the network participant 104 regarding the payment made by content source website 110 for the profile data that the network participant 104 has shared with content source 110 through the PCU 102.

At step 332, the network participant 104 evaluates marketing communications. It is determined whether the network participant 104 confirms the selling of the requested attributes of the profile data at the said price. If the network participant 104 does not agree with the content source website 110 for the exchange of the attributes of the profile data for the said price, then at step 334, a content source report is generated and the content source website 110 is notified about the refusal of the network participant 104 to exchange the profile data. The method terminates at step 352. Also, if the content source website 110 does not make the open bid rate or other pricing proposal, the method terminates at step 352. If the network participant 104 confirms the sale of the requested attributes of the profile data at the said price, then the control goes to the step 318.

Once the report is provided to the content source website 110 by the PCU 102 at the step 318 (a document block), then at step 346 it is determined whether the content source website 110 is interested in having a promotional or research effort for the network participant 104 based on the report. If the content source website 110 is not interested in having a promotional or research effort for the network participant 104, then the method terminates at step 352. Otherwise, at step 344, the content source website 110 submits tokens and requests promotional or research effort cost proposal to the PCU 102.

At step 342, if the content source website 110 decides to move forward to having a direct marketing campaign based on the promotional or research effort cost proposal, then at step 340, a payment is made to a mutually trusted partner. At step 338, an electronic web based direct marketing campaign is implemented. At step 336, a response is documented and the invoice is generated. In case the electronic web based direct marketing campaign, for example an email is not read, and then no fee is paid. The control goes to step 326. At step 348 a traditional direct marketing campaign is implemented. At step 350, the fee is deducted and the control goes to the step 326. The method terminates at step 352.

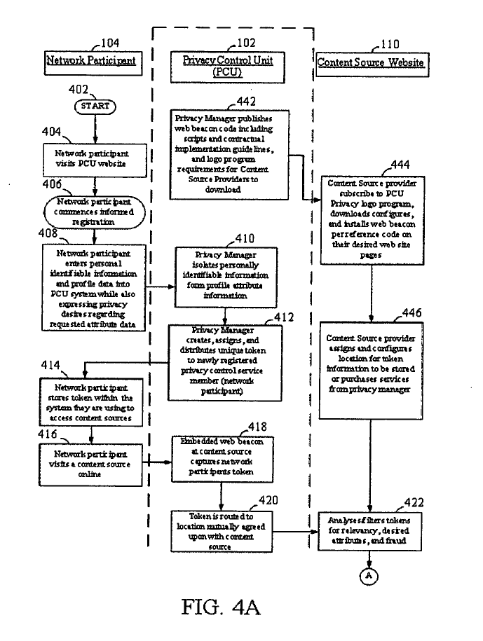

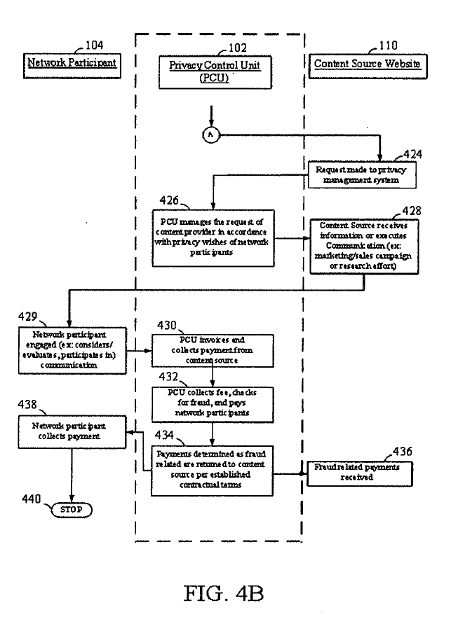

FIG. 4-A, B is a flow diagram illustrating the tasks performed by the network participant 104, the PCU 102 and the content source website 110 for providing secure exchange of the profile data between the network participant 104 and the content source website 110 through the PCU 102. The steps performed by the network participant 104 are shown with reference to blocks below the network participant 104, the steps performed by the PCU 102 are shown with reference to blocks below the PCU 102 and the steps performed by the content source website 110 are shown with reference to blocks below the content source website 110. At step 404, the network participant 104 visits the content source website 110.

At step 406, the network participant 104 registers the profile data with the PCU 102. At step 408, the network participant 104 enters personally identifiable information and the profile data in the PCU 102 and assigns privacy levels to each of the attributes of the profile data. At step 410, the personally identifiable information is distinguished and separated logically and physically from the non-identifiable profile data by the PCU 102. Thereafter, at step 412, the PCU 102 creates and distributes anonymous token to the network participant 104. At step 414, the token is stored in a web browser in the network participant 104 in accordance with standard industry practices regarding cookie or token storage and management. At step 416, the content source website 110 is visited by the network participant 104. At step 418, a web beacon (an extension of the PCU 102 at the content source website 110) collects the token from the network participant 104. The web beacon being embedded at the content source website 110. At step 420, the token is routed to the location mutually agreed between the content source website 110 and the PCU 102.

At step 442, the PCU 102 publishes a web beacon code, scripts, contract implementation guidelines and logo requirements. The web beacon code is available for download for the content source website 110. At step 444, the content source website 110 subscribes to the PCU 102 and downloads the web beacon code and configures the code. Thereafter at step 446, the content source website 110 installs and configures the web beacon code on a desired page of the content source website 110. The web beacon code may collect the token of registered network participants, for example, the network participant 104 registered with the PCU 102 that visits the page upon which the web beacon is deployed. Additionally, the web beacon may act as a link to the PCU 102 registration page that may be spawned in a separate browser window if clicked upon by the network participant 104 on the content source website 110. The web beacon also informs the PCU 102 manager regarding the location of the web beacons placement. Further, if a logo is displayed, then a number of visits made to the web beacon location by network participants with the PCU 102 during a specific time period can be calculated.

Further, the web beacon code may comprise information about implementation of the web beacon, preconfigure default profile data by the prospective network participant with the PCU 102, and contain data used to inform secondary channel relationships associated with the deployment of the web beacon. Further, the web beacon code may be hosted by a third party agent identified in the web beacon data associated with hosted content source websites 110, 112 and 114 that is accessed by the PCU 102. The third party agent is a proxy manager for content source websites 110, 112 and 114. The third party agent manages the use of the PCU 102 on behalf of the content source owners. At step 422, the content source website 110 analyses/filters the tokens for relevancy, desired attributes of the plurality of attributes of the profile data, and presence of fraudulent tokens (if any).

At step 424, the content source website 110 requests to the PCU 102 for the profile data corresponding to the token. At step 426, the PCU 102 manages the request of the content source website 110 in accordance with the privacy levels assigned to each of the attributes. At step 428, the content source website 110 receives the profile data and executes at least one of an inbound research or an outbound promotion marketing campaign. At step 429, the network participant 104 is engaged in the promotion campaigns where he or she consider, evaluate or participate in a communication. At step 430, the PCU 102 charges the content source website 110 for executing the promotion marketing campaign and providing the profile data requested by the content source website 110 from the PCU 102. The PCU 102 generates an invoice and collects payment from the content source website 110. At step 432, the PCU 102 collects the payment and checks for fraud. Further, the PCU 102 pays the network participant 104 for providing the profile data to the PCU 102. At step 434, any unresolved fraud related payments held in escrow are returned to the content source website 110 as per established contract terms. At step 436, the fraud related payments are received by the content source website 110. At step 438, the network participant collects the payment associated with their participation. The method terminates at step 440.

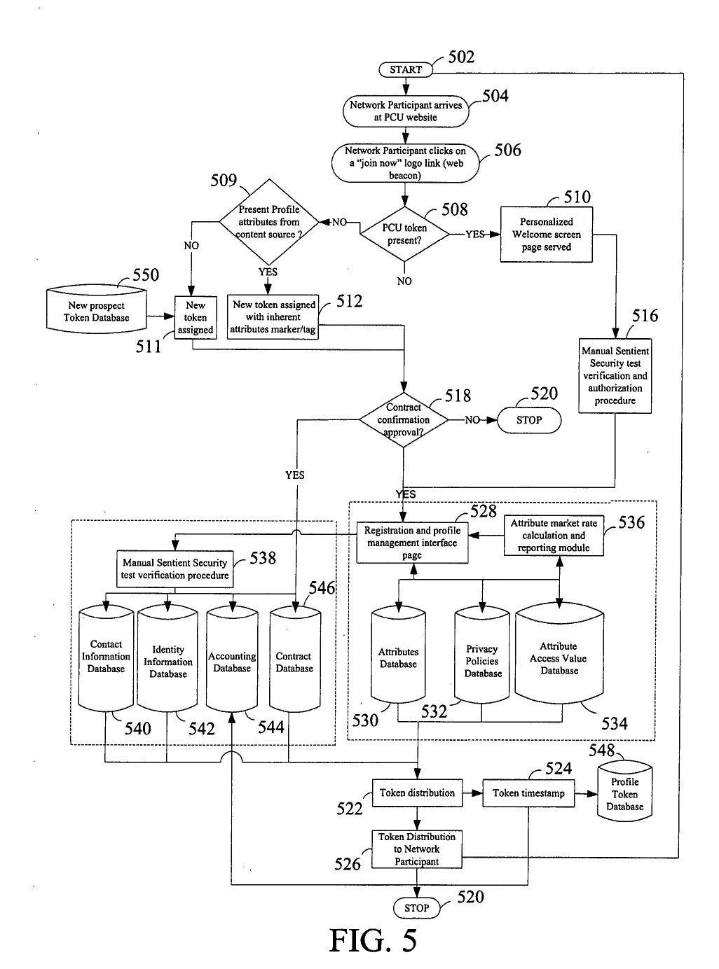

FIG. 5 is a flow diagram along with the interactions with the databases for assignment of the token to the network participant. The method is initiated at step 502. At step 504, the network participant 104 visits the content source website 110. If the network participant 104 has not registered the profile data with the PCU 102 or if the network participant 104 has already registered (however, the token is not present in the network participant 104, because of deletion of the token), then at step 506, the network participant 104 clicks on a “join now” link on the content source website. At step 508, the PCU 102 checks whether the token is present in the network participant 104. If the token is present, then the network participant has already registered with the PCU 102. If the network participant 104 has already registered with the PCU 102, then at step 510, a personalized welcome screen appears on the PCU 102.

If the token is not present then at step 509, it is determined whether each of the attributes of the profile data are from the content source website 110, if yes then at step 512 a temporary token is assigned and the control goes to the step 518. Otherwise, if each of the attributes of the profile data is not from the content source websites 110, then at step 511, a new token is assigned using a new token prospect database 550. At step 516, verification and an authorization procedure is done by the PCU 102. Thereafter, at step 528 registration and profile management page appears on the PCU 102. The profile management page is linked to an attributes database 530, a privacy policies database 532 and an attribute access value database 534. The attributes database 530 includes a plurality of attributes corresponding to the profile data, the examples of attribute data include but are not limited to demographics data, psychographic data, top of mind keywords, web browser behavior, trigger life events, for example birthdays, anniversaries major purchases, offline purchase behavior, and personal content that expresses a network participant's viewpoint on specific subject matter.

The privacy policies database 532 includes the privacy level assigned to each of the plurality of attributes of the profile data. The attribute access value database 534 includes the monetary values associated with each of the plurality of attributes of the profile data. All attribute data is physically and logically separated from identifiable data. Logical, physical, and operational separation of the storage, access and use of personally identifiable data and non-identifiable data, leads to data access authentication and authorization, thereby assuring data privacy internally and externally. At step 536, the attribute market rate calculation is done by the PCU 102. Further, if the network participant 104 has been sourced by the web beacon, then some properties and the plurality of attributes may be preset in the attributes database 530. At step 518, it is determined whether the network participant 104 agrees to the contracts terms and conditions laid out by the PCU 102. If the network participant 104 agrees to the contract terms and conditions, then contract information corresponding to the network participant 104 is stored in a contract database 546 and the control goes to the step 528. At step 538, the PCU 102 manually checks the contract information and the contract information may be used to inform antifraud efforts. Thereafter, the contract information is stored in a contact information database 540.

Identity information, for example, name and address is stored in an identity information database 542. Further, a new account corresponding to the network participant 104 is created and details regarding the new account are stored in the accounting database 544. Thereafter at step 522, the token distribution is done. At step 524, a timestamp is attached with the token and the token is stored in a profile token database 548. At step 526, the token is distributed to the network participant 104. The method terminates at step 520.

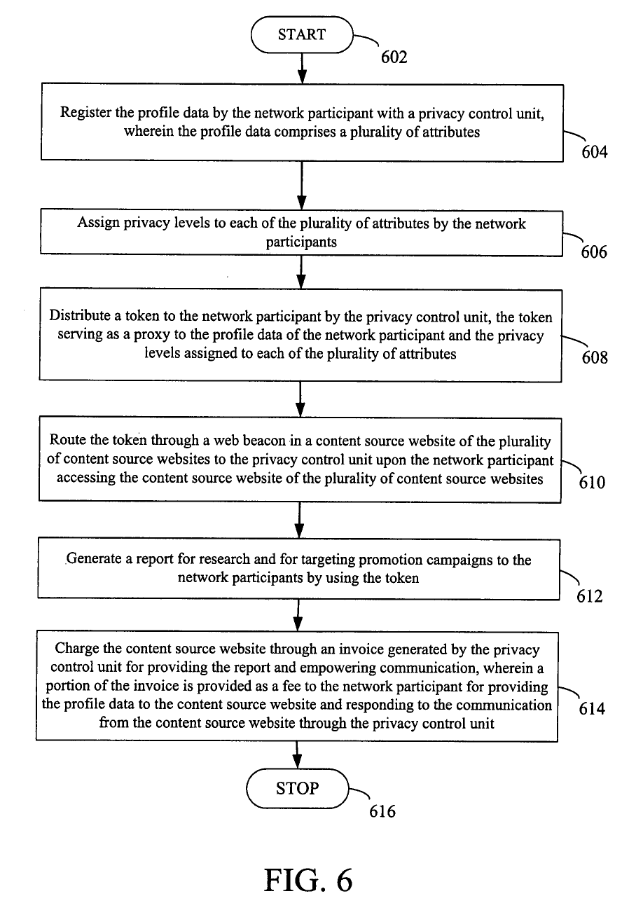

FIG. 6 is a flow diagram illustrating a method for providing secure exchange of the profile data of the network participant 104 between the network participant 104 and the plurality of content source websites 110, 112 and 114. The method is initiated at step 602. At step 604, the profile data is registered by the network participant 104 with the PCU 102, and the network participant's personally identifiable information and non identifiable information are separated. At step 606, the network participant 104 assigns privacy levels to each of the plurality of attributes of the profile data. At step 608, a token is distributed to the network participant 104 by the PCU 102; the token serves as a proxy for the profile data of the network participant 104 and the privacy levels assigned to each of the plurality of attributes of the profile data. At step 610, the token is routed through a web beacon in a content source website 110 of the plurality of content source websites 110, 112 and 114 to the PCU 102 upon the network participant 104 accessing the content source website 110 of the plurality of content source websites 110, 112 and 114. At step 612, a report is generated based on the profile data for at least one of a marketing research or outbound marketing promotion campaigns to the network participant 104 by using the token.

At step 614, the content source website 110 is charged through an invoice generated by the PCU 102. A portion of the invoice is provided to the network participant 104 for providing the profile data and/or reviewing promotions delivered to the network participant 104 by the PCU 102. The portion of the invoice provided to the network participant 104 is consistent with a quality and volume of the profile data provided by the network participant 104, for example if the network participant 104 provides more and rich profile data compared to the network participant 106, the network participant 104 receives more fees as compared to the network participant 106. Further, a portion of the invoice is deducted from the payment to the network participant 104 for providing the brokerage and privacy services through the PCU 102. The method terminates at step 616.

The network participant service module 118 provides a user interface that provides for the prioritized presentation of direct marketing communications by content source or organizations to registered network participants, for example network participants 104, 106 and 108. The Privacy Control Unit 102 assigns each marketing communication targeted to and received by a registered network participant with a relevancy score. The relevancy score assigned to the each marketing communication determines placement of the marketing promotions campaigns with the registered network participant 104. Communications with a higher relevancy scores are given greater visual prominence within the user interface as they are deemed more aligned with the needs, wants, desires of the registered network participant 104. The network participant 104 evaluation of marketing communications is greatly expedited by the fact that the communications have been presorted prior to presentation to the network participant 104.

Presorting of marketing communications is a function of personal attributes associated with each registered user and attributes associated with the marketing communication. The PCU 102 determines affinity of the desired target audience of the content source or organization and attributes within the profile data of the registered network participant 104. Attributes included within the network participant 104 profile include rich demographic data, psychographic data, keyword alignment, online browser behavior, personal viewpoints, and occurrence of trigger events including life events and purchases. Attributes included within the marketing communication include the payment made to the registered network participant 104 for evaluation and the monetary value of the marketing communication. Both the monetary value for consideration of the marketing communication and the value of the promotion are made visually evident in the user interface of the registered network participant 104. Additionally, the network participant 104 may sort the marketing communications based upon several criteria including: the value to consider or evaluate in the marketing communication, the value of the marketing communication, the organization or content source responsible for the communication, the expiration date and the general category of the promotion.

The PCU 102 manages the presentation on marketing communications to registered network participants, for example network participants 104, 106 and 108 from content source web sites 110, 112, and 114. The PCU 102 calculates affinity of the profile data targeted by a content source and the plurality of attributes of the profile data of the targeted registered network participant, for example the network participant 104. Attributes narrow the scope of the communication to a finite group of registered network participants as determined by the intended scope of the promotion as defined by the resources allocated by the content source, for example the content source 110 for the marketing communication campaign. After the scope has been narrowed based on core targeting criteria a richer affinity calculation is made using a mathematical algorithm, the output of the mathematical algorithm results in the relevancy score, which is assigned to each marketing communication. The relevancy score is then used to determine the relative placement of the marketing communications in the user interface of the network participant 104 relative to other marketing communications received by the network participant 104.

The relevancy score is calculated using scores defined to each of a plurality of affinity categories. The plurality of affinity categories includes online behavior, demographic correlation, keyword correlation, payment for evaluation, promised savings, ease of readability and offline behavior. The online behavior includes the online behavior of the registered network participant, for example whether a registered network participant visited a target content source website. The demographic correlation includes the correlation of a target profile data demographic and life trigger events defined by the content source 110 to that defined by a registered network participant 104. The keyword correlation includes the correlation of the keywords entered in by the content source website 110 relative to those entered by the registered network participant 104. The payment for evaluation includes a relative open bid rate value associated with the marketing communication. The promised savings includes the non-cash monetary value associated with the marketing communication. The ease of readability includes the use of the PCU 102 for marketing communication formatting template and the use of a custom template. The offline behavior is the consumption trigger event, for example purchase of a new home, a mobile phone and a gaming console.

For each of the plurality of affinity categories, a range of scores is subcategorized into a plurality of tiers. Each of the plurality of tiers is assigned a value or relevancy points. Depending on where a score is within the range of scores a certain number of relevancy points are assigned to an affinity category of the plurality of affinity categories. Once each of the plurality of tiers is assigned the value, a relevancy-weighting factor is applied to the plurality of tiers and each of the plurality of affinity categories. The value for each of the plurality of tiers and each of the plurality of affinity categories weighting factor is multiplied by its respective category and value for each of the plurality of tiers to determine a contribution to the overall relevancy score by each of the plurality of affinity categories. The scores in each of the plurality of affinity categories are added to derive the final relevancy score for the communication. Further, if more indicators of purchase interest or intent are made accessible to the PCU 102 manager, then the indicators of purchase intent can be incorporated into a relevancy algorithm. Additionally, sub algorithms based on behavior of registered network participant 104 may be used to define appropriate weighing factors.

A relevancy computation Table 1 below is used for computing the relevancy score.

$$\begin{matrix}\begin{matrix}Affinity category 1 score \\ \begin{matrix}Tier 1 range & = \# tier 1 relevancy points \\ Tier 2 range & = \# tier 2 relevancy points \\ Tier 3 range & = \# tier 3 relevancy points \\ Tier X … range & = \# tier X relevancy points\end{matrix} \times \begin{matrix}Tier weighting multiple \\ Tier weighting multiple \\ Tier weighting multiple \\ Tier weighting multiple\end{matrix} \times \begin{matrix}\begin{matrix}Weighting \\ multiple for\end{matrix} \\ \begin{matrix}affinity \\ category 1\end{matrix}\end{matrix}\end{matrix} & = & \begin{matrix}\begin{matrix}Weighted \\ category 1\end{matrix} \\ score\end{matrix} \\ & & + \\ \begin{matrix}Affinity category 2 score \\ \begin{matrix}Tier 1 range & = \# tier 1 relevancy points \\ Tier 2 range & = \# tier 2 relevancy points \\ Tier 3 range & = \# tier 3 relevancy points \\ Tier X … range & = \# tier X relevancy points\end{matrix} \times \begin{matrix}Tier weighting multiple \\ Tier weighting multiple \\ Tier weighting multiple \\ Tier weighting multiple\end{matrix} \times \begin{matrix}\begin{matrix}Weighting \\ multiple for\end{matrix} \\ \begin{matrix}affinity \\ category 2\end{matrix}\end{matrix}\end{matrix} & = & {\underline{\underline{\begin{matrix}\begin{matrix}Weighted \\ category 2\end{matrix} \\ score\end{matrix}}}}_{\begin{matrix}Relevancy \\ score 1 + 2 + …\end{matrix}}\end{matrix}$$

FIG. 7 is a flow diagram of the method for secure exchange of the profile data between the network participant 104 and a plurality of content sources. As used herein, the plurality of content sources are organizations interested in the profile data of the network participants. Such organizations may retrieve the profile data from the PCU 102 without having a website and deploying the web beacon. The method initiates at step 702. At step 704, a software is installed on the network participant 104. The software monitors use and behavior pattern of the network participant 104 upon network participant 104 confirming the installation of the software. The software is one of a toolbar or other client based monitoring application installed on the network participant 104 by the PCU 102. The software may be voluntarily downloaded and installed by the network participant 104. By installing the software, the network participant 104 confirms to the terms and conditions regarding the functionality of the software for collecting the profile data. Data collected by the software installed by the network participant on a computing device is independent of the web beacon methods and this data is brokered by the PCU 102 to third parties in a manner consistent with the privacy interests and financial obligations of a trusted broker relationship between the network participant and the PCU 102.

Further, the network participant 104 has control of being notified when monitored and type of data (for example, the profile data) being transferred to the PCU 102. At step 706, the profile data along with privacy levels assigned to each of a plurality of attributes of the profile data is transferred to the PCU 102 periodically through the software installed on the network participant 104. Further, network addresses data collected is transferred to the PCU 102 and stored in a manner that preserves a privacy of the network participant 104. The privacy is maintained by associating the behavior pattern of the network participant 104 with an anonymous token as opposed to a name or other personally identifiable data associated with the network participant 104.

At step 708, a report is generated for research and for targeting promotion campaigns to the network participant 104 by using the profile data transferred through the software. The report is generated by the PCU 102. At step 710, the report generated by the PCU 102 can be accessed by the plurality of content sources for communications with the network participant 104. The plurality of content sources is registered with the PCU 102. The communications with the network participant 104 may be for a direct marketing or promotional marketing campaigns or other purpose. The plurality of content sources are charged by the PCU 102 through an invoice generated by the PCU 102 for providing the report and empowering communications. A portion of the invoice is provided as a fee to the network participant 104 for providing the profile data to the plurality of content sources and responding to communications through the PCU 102.

The PCU 102 can charge a subscription based or fixed cost to the content sources for providing the profile data to the content sources. Further, per network participant unit of volume, or any other pricing proposals are possible in the said method. The method terminates at step 710.

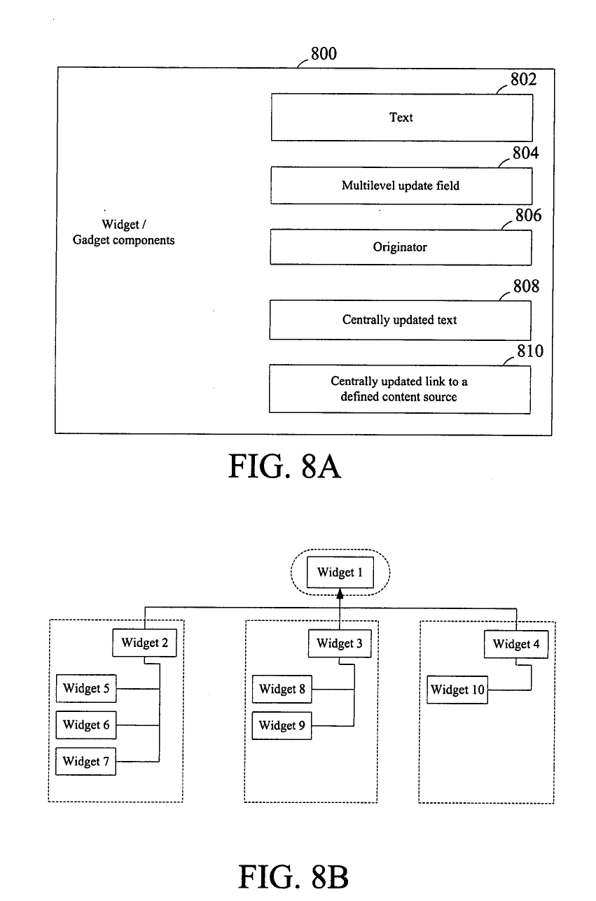

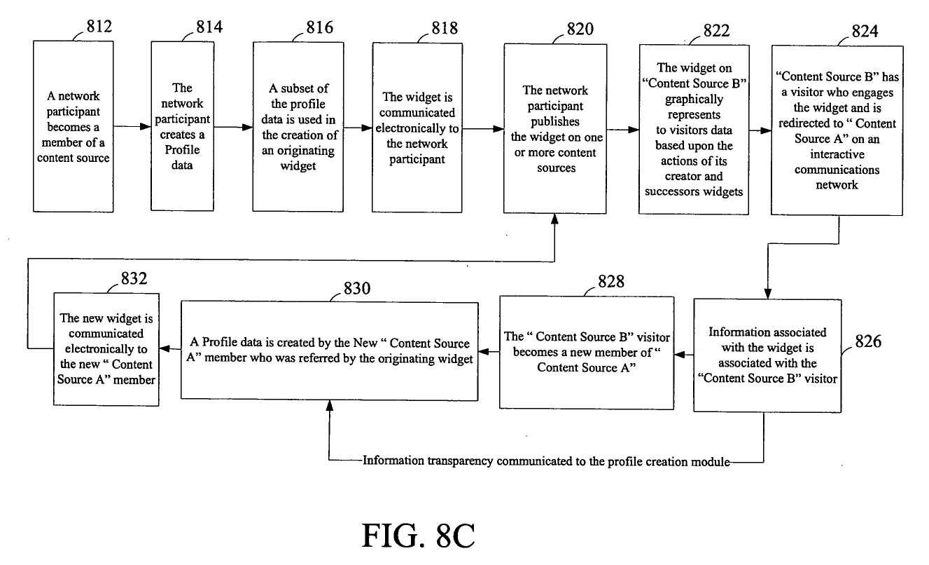

FIG. 8A is a block diagram of a widget 800 deployed on the network participant 104, according to an embodiment of the present invention. The widget 800 is a portable software component or small application called by various names including a web widget, badge, module, capsule, snippet and flake. The software component is downloaded from a remote location and installed and executed on either the computing device, or within one or more separate remote browser-based content aggregation platforms or community or web application services by a service member without requiring additional compilation.

Further, the software component can be linked to a remote server location and presents locally to a plurality of users with a data residing at the remote server. In the present invention, the widget 800 serves a very similar functionality to the web beacon in the content source website 110. The widget 800 serves the functionality of communicating the data about the content source websites 110, 112 and 114 to the PCU 102 to empower the system 100 to account for traffic at the content source websites 110, 112 and 114 and recognize and reward the value of the network participant that refer new members as network participants to the system 100. Furthermore, the widget provides a visual expression of the network participant 104 transference of the fee obtained from the PCU 102 to a specified third party, for example a charity organization. Moreover, the widget can be deployed on a social networking site by the network participant 104; thereby the access of the widget by a friend of the network participant on the social networking site results in a certain sum of money being transferred to the third party.

The widget 800 includes a text 802, a multi level update field 804, an originator 806, a centrally updated text 808, and a centrally updated link to a defined content source 810. The multi level update field 804 is used for transparently inheriting the plurality of attributes of the profile data of the network participant 104 by another network participant, for example 106 using the widget on the network participant. Each of the network participants using the widget on the network participant 104 inherits the plurality of attributes of the network participant 104. The centrally updated text 808 includes the text defined at the remote server. The centrally updated link to the defined content source 110 is specified in a central database that can be dynamically updated from a central location.

FIG. 8B is an example of the multilevel marketing widget, according to an embodiment of the present invention. The properties of the widget sets the properties of future widgets created by network participant, for example the network participant 104. By way of example, the widget 1=sum (2, 3, 4, 5, 6, 7, 8, 9), and future widgets will exhibit properties such as widget 2=sum (5, 6, 7), widget 3=sum (8, 9), widget=sum (10). Further, any network participant being referred can override a default configuration the network participant inherits from the initial widget initiator when the network participant fills out the profile data. The post creation changes to the original widget may or may not be inherited by its descendent depending upon a setting of the widget creation tools.

FIG. 8C is a flow diagram of an operational process of the multilevel marketing widget creation and propagation. At step 812, a network participant, for example the network participant 104 becomes a member of a content source, for example a content source A. At step 814 a profile data is created by the network participant 104, at step 816, a subset of the profile data is used in a creation of an originating widget. At step 818, the widget is communicated electronically to the network participant 104. At step 820, the network participant or a proxy publishes the widget on a plurality of content sources called herein as content source B. At step 822, the widget on the content source B graphically represents data to visitors based upon actions of the originating widget and the successors. At step 824, the content source B has a visitor prospect, who engages the widget and is redirected to the content source A on an interactive communications network. At step 826, information associated with the widget is associated with the content source B visitor. At step 828, the content source B visitor becomes a new member of content source A. At step 830, a profile data is created by the new member of the content source A, the new member of the content source A was being referred to by the originating widget. Further, the default setting of the subset of the data in the new member profile is preconfigured by the profile data residing in the original widget, but the subset of the data can be changed by the new member. At step 832, the new widget created is automatically electronically communicated to new member of the content source A. The control goes to step 820.

The present invention allows the user to remotely create and manage a secure online profile on the PCU 102. The secure online profile is composed of a plurality of attributes voluntarily provided and stored in the multiple data base, for example, the database 204 and the database 206. The PCU 102 manager can associate a monetary values corresponding to each of the plurality of attributes of the profile data. The PCU 102 associates a token with each network participants profile data. The token serves as a proxy identifier to the profile data associated with the network participant 104 that is maintained by the PCU 102. The content source website 110 uses the tools provided by the PCU 102 which access the tokens to gain access to the profile data and target communications to the network participant 104. The content source website 110 is capable of accessing the profile data as per established contract terms. The token exchanged between the network participant 104, the PCU 102, and the profile data presented to the content source website 110 conforms to internet privacy guidelines and technical standards governing creation and dissemination of tokens.

Further, secure authentication, authorization, accounting, technical encryption and encapsulation is provided by the PCU 102 for ensuring restriction of the access of the profile data of the network participant 104 to PCU 102 administrators and of the plurality of content sources 110, 112 and 114. The PCU 102 web beacon specific data sourced from web beacons implemented in the content source websites 110, 112, 114 are constrained to their respective content source websites 110, 112 and 114. The profile data collected independent of the web beacons directly from the registered network participants 104, 106, 108 is brokered in accordance with the contractual fiduciary responsibilities of PCU 102 manger to registered network participants. Online usage and potentially offline purchase data/patterns of the network participant 104 sourced directly from the network participant via voluntarily installed monitoring software on their computing devices is brokered in a manner consistent with their contractual agreements with the PCU 102 manager. Statistical aggregation of data and contractual agreements with individuals and organizations that use PCU 102 web privacy content source privacy module 120 subset tools ensure that parameters such as network usage, sales conversion rates, and a specific page accessed on the content source website 110 cannot be used by the content source website for collecting the profile data by the content source website, unless the network participant 104 has allowed the content source website 110 to do so, in the privacy levels assigned to the profile data.

The user may access the network from the plurality of computing devices, the user acting in different capacities each time, for example as an ordinary user, as a business professional, or as a self employed individual. The PCU 102 provides a login identification and a password, or other means of authentication, for enabling the network participant to log into the PCU 102 from the plurality of computing devices. The PCU 102 may associate a plurality of tokens for each of the plurality of computing devices from which the user logs into the PCU 102. Accordingly, the plurality of tokens is mapped to a single profile data corresponding to the user. Hence the PCU 102 centralized presentation of promotions eliminates redundancy and double counting, since the PCU 102 maps the plurality of tokens to the single profile data. Further the PCU 102 can allow content source websites 110, 112 and 114 and other organizations direct promotional campaigns to network participants 104, 106 and 108 business contact information or personal contact information independent of the computing device used to access the content source website.

In another embodiment of the present invention, a single token can be assigned to one or more users. For example, an organization may desire a single token for all purchasing managers. In that case, when the purchasing managers accesses the PCU 102, then a profile data of the organization is provided and not of an individual. Further two tokens can be assigned to a purchasing manager, a first token for the profile data as the individual and the second token for the profile data of the organization. Thereby enabling the organization to better direct and control communications and potentially generate more revenue from online activity of the purchasing managers. By controlling access in this manner to key personnel, an organization can monetize its employee base and easily separate vendors that have conviction in the value of their services from those that do not.

In another embodiment of the present invention, a platform vendor is capable of developing a system that allows network participants 104, 106, 108 to supplement the tokens distributed to them by the PCU 102 with more information about themselves. Such a system makes it possible to sell select information to the content source website 110. Alternatively, the platform vendor creates application interface for cookie management that allows the network participant 104 to send the cookie data alongside traditional server “get” command exchange between a web server and a browser. Also, the platform vendor is capable of redefining the parameters of the tokens and leverage increased functionality to provide a service that precludes the need for the content source website to solicit the profile data, for example the content source website 110, to have a script in the page of the content source website 110. This code would interface with client side code distributed in the browser in a transparent manner. Hence, simplifying the go to market model in which the content source website 110 implement web beacons for collecting the tokens.

In yet another embodiment of the present invention, the platform vendor can use a cookie tag or cookie plus to create a way for extending cookies, thereby allowing the network participant 104 to append data to the tokens. Also, a web tool is developed for profile cookie enabling the user accessing the content source website 110, to transfer the profile data. The transfer of the profile data happens when the user confirms that he or she is willing to transfer the profile data. The user will be paid a fee for providing the profile data to the content source website 110. Query software also can be distributed by the content source website 110 to the user that visits the content source website 110. The query software searches the computing device of the user and compiles the profile data of the user that is distributed back to the content source website 110.

The present invention provides a method exchanging the profile data by maintaining the privacy and enables permission based marketing research and promotion. The present invention also allows the network participant 104 to be compensated for providing the profile data. Furthermore, the system empowers the assignment of the fees to the network participant to third parties, for example a charitable trust.

The present invention results in an exponential improvement in targeting the promotional campaigns because it provides a framework to meet the disparate data privacy interests of network participants and content sources (usually business organizations). In the present invention the report is generated based on the interaction between the content source website 110 and the PCU 102. Further, the secure exchange of the profile data in the present invention is transparent to the network participant 104. Also, the present invention allows the content source website 110 to select, negotiate, and purchase at a self selected market rate a plurality of attributes of the profile data with the PCU 102. The present invention allows the content source websites to respond quickly to the highly qualified network participants in timely manner with direct promotions, thereby improving the efficiency of the marketing effort.

As described above, the embodiments of the invention may be embodied in the form of computer-implemented processes and apparatuses for practicing those processes. Embodiments of the invention may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is understood that various omission and substitutions of equivalents are contemplated as circumstance may suggest or render expedient, but such modifications are intended to cover the application or implementation without departing from the spirit or scope of the claims of the present invention.

What is claimed is:

1. A method for secure exchange of a profile data of a network participant between the network participant and a plurality of content source websites, the method comprising:
registering the profile data by the network participant with a privacy control unit, wherein the profile data comprises a plurality of attributes;
assigning privacy levels to each of the plurality of attributes by the network participant;
distributing a token to the network participant by the privacy control unit, the token serving as a proxy for the profile data of the network participant and the privacy levels assigned to each of the plurality of attributes;
routing the token through a web beacon in a content source website of the plurality of content source websites to the privacy control unit upon the network participant accessing the content source website of the plurality of content source websites;
generating a report for research and for targeting promotion campaigns to the network participant by using the token, wherein the report is generated by the privacy control unit; and
charging the content source website through an invoice generated by the privacy control unit for providing the report and empowering communications to a targeted set of network participants while preserving the network participants privacy, wherein a portion of the invoice is provided as a fee to the network participant for providing the profile data to the content source website and responding to the communications from the content source website through the privacy control unit.

2. The method of claim 1, wherein the targeting and presentation of communications to network participants is done by computing a multi-faceted relevancy score based upon the affinity of a target audience specified by a content source and voluntarily supplied profile data maintained by a network participant.

3. The method of claim 1, wherein the fee of the network participant is transferred to a third party using a widget, wherein the widget is a software component installed on the network participant.

4. The method of claim 1, wherein the web beacon provides the privacy control unit with at least one of the token, browser statistics of the network participant, recipient of the fee to the network participant, and information about an organization that deployed the web beacon.

5. The method of claim 1, further comprising calculating and communicating the fees applicable for registering and managing the profile data and responding to the targeted promotion campaigns through the privacy control unit.

6. The method of claim 1, wherein the network participant is one of an internet service subscriber, a network application and a user of a computing device in a network.

7. The method of claim 1, wherein the network participant is the user of the computing device in the network and the user is capable of accessing the content source website through a plurality of computing devices in the network, and wherein a token corresponding to each of the plurality of computing devices corresponds to the profile data.

8. The method of claim 1, wherein the content source website of the plurality of content source websites is one of a web site, a file server, a network server and an operator of the content source website.

9. The method of claim 1, wherein the exchange of the profile data using the token through the privacy control unit between the network participant and the content source website is independent of a usage pattern of the network participant and information registered by the network participant at the content source website.

10. The method of claim 1, further comprising auditing a quality of the profile data by the content source website for evaluating the legitimacy of the profile data.

11. A method of secure exchange of a profile data of a network participant between the network participant and a plurality of content sources, the method comprising:
installing a software on the network participant, the software monitoring use and behavior pattern of the network participant upon network participant confirming the installation of the software;
transferring the profile data along with privacy levels assigned to each of a plurality of attributes of the profile data to a privacy control unit periodically through the software installed on the network participant;
generating a report for research and for targeting promotion campaigns to the network participant by using the profile data transferred through the software, wherein the report is generated by the privacy control unit;
accessing the report by the plurality of content sources for communications with the network participant, wherein the plurality of content sources are registered with the privacy control unit; and
charging the plurality of content sources through an invoice generated by the privacy control unit for providing the report and empowering communications, wherein a portion of the invoice is provided as a fee to the network participant for providing the profile data to the plurality of content sources and responding to communications through the privacy control unit.

12. The method of claim 11, wherein the software is a client based application installed on the network participant.

13. The method of claim 11, wherein the privacy levels are assigned using an anonymous token associated with the profile data of the network participant.

14. A system comprising:
a plurality of network participants, wherein each network participant of the plurality of network participants associated with a profile data, the profile data comprising a plurality of attributes;
a plurality of content source websites, wherein each network participant of the plurality of network participants is capable of accessing the plurality of content source websites; and
a privacy control unit in operative communication with the plurality of network participants and the plurality of content source websites, the privacy control unit comprising
a database for storing the profile data and privacy levels for each of the plurality of attributes of the profile data associated with each of the plurality of network participants, wherein each network participant registers the associated profile data and assigns the privacy levels for each of the plurality of attributes of the associated profile data with the privacy control unit,
a token management system capable of
distributing a token of a plurality of tokens to a network participant of the plurality of network participants, the token serving as a proxy for the profile data of the network participant and the privacy levels assigned to each of the plurality of attributes of the profile data, and
routing the token through a web beacon in a content source website of the plurality of content source websites to the privacy control unit upon the network participant accessing the content source website of the plurality of content source websites,
a business intelligence module for generating a report for research and for targeting promotion campaigns to the plurality of network participants by using the plurality of tokens, and
an accounting module capable of
invoicing the content source website of the plurality of content source websites, and
providing a fee to the network participant for providing the profile data and responding to communications from the content source website through the privacy control unit.

15. The system of claim 14, further comprising a web application service module for calculating and communicating the fees applicable for registering the profile data and responding and managing the profile data and responding to the targeted promotion campaigns through the privacy control unit.

16. The system of claim 14, wherein the network participant of the plurality of network participants is one of an internet service subscriber, a network application and a user of a computing device in a network.

17. The system of claim 14, wherein the content source website of the plurality of content source websites is one of a web site, a file server, a network server, a software application server, and an operator of the content source website.

18. The system of claim 14, wherein the exchange of the profile data through the token between the network participant and the content source website is independent of a usage pattern and information registered by the network participant at the content source website.

19. The system of claim 14, wherein the fee of the network participant is transferred to a third party specified as a recipient by the network participant.

20. The system of claim 19, wherein the third party is specified as the recipient using the web beacon.

21. The system of claim 19, wherein the third party is specified as the recipient using a widget, wherein the widget is a software component installed on the network participant.

22. A computer program product embodied on a computer readable medium for secure exchange of a profile data of a network participant between the network participant and a plurality of content source websites, the computer program product comprising a program module having instructions for:
registering the profile data by the network participant with a privacy control unit, wherein the profile data comprises a plurality of attributes;
assigning privacy levels to each of the plurality of attributes by the network participant;
distributing a token to the network participant by the privacy control unit, the token serving as a proxy for the profile data of the network participant and the privacy levels assigned to each of the plurality of attributes;
routing the token through a web beacon in a content source website of the plurality of content source websites to the privacy control unit upon the network participant accessing the content source website of the plurality of content source websites;
generating a report for research and for targeting promotion campaigns to the network participant by using the token, wherein the report is generated by the privacy control unit; and
charging the content source website through an invoice generated by the privacy control unit for providing the report and empowering communications, wherein a portion of the invoice is provided as a fee to the network participant for providing the profile data to the content source website and responding to the communications from the content source website through the privacy control unit.

23. The computer program product of claim 22, wherein targeting promotion campaigns to the network participant is done by computing a relevancy score for the network participant.

24. The computer program product of claim 22, wherein the fee of the network participant is transferred to a third party using a widget, wherein the widget is a software component installed on the network participant.

25. The computer program product of claim 22, wherein the web beacon provides the privacy control unit with at least one of the token, browser statistics of the network participant, recipient of the fee to the network participant, and information about an organization that deployed the web beacon.

26. The computer program product of claim 22, further comprising calculating and communicating the fees applicable for registering and managing the profile data and responding to the targeted promotion campaigns through the privacy control unit.

27. The computer program product of claim 22, wherein the network participant is one of an internet service subscriber, a network application and a user of a computing device in a network.

28. The computer program product of claim 22, wherein the network participant is the user of the computing device in the network and the user is capable of accessing the content source website through a plurality of computing devices in the network, and wherein a token corresponding to each of the plurality of computing devices corresponds to the profile data.

29. The computer program product of claim 22, wherein the content source website of the plurality of content source websites is one of a web site, a file server, a network server and an operator of the content source website.

30. The computer program product of claim 22, wherein the exchange of the profile data using the token through the privacy control unit between the network participant and the content source website is independent of a usage pattern of the network participant and information registered by the network participant at the content source website.

31. The computer program product of claim 23, further comprising auditing a quality of the profile data by the content source website for evaluating the legitimacy of the profile data.
